(19) United States
(12) Patent Application Publication
(10) Pub. No.: US 2012/0240438 A1
(43) Pub. Date: Sep. 27, 2012

(54) Elongated sign receiving arrangements

(76) Inventors: David E. Pitcher, Swampscott, MA (US); Rebecca C. Suciu, Lynn, MA (US); Thomas P. Burrous, Haverhill, MA (US); Alan L. Stenfors, Scituate, MA (US); Sidney Rose, Marblehead, MA (US)

(21) Appl. No.: 13/065,660

(22) Filed: Mar. 25, 2011

(51) Int. Cl. G09F 15/00; G09F 7/18

(52) U.S. Cl. 40/611.06

(57) ABSTRACT

An elongated system for independently supporting a plurality of elongated signs from a plurality of sides and edges thereof from a common extrusion, comprising a slidable first side sign holder, a slidable second side sign holder, a slidable lower edge third sign holder. An end cap is arranged at each end of the system for securing the plurality of signs within the system.

### BACKGROUND OF THE INVENTION

1. Field of the Invention

This invention relates to elongated sign supports particularly for use I commercial settings where changes in displays are frequent and necessary.

2. Prior Art

Sign holders are ubiquitous in commercial establishments. Such signs are usually supported from an overhead support which is coupled to the ceiling. The signs are of necessity, changed frequently. There is a need for permitting multiple signs to be supported from a common sign holder. There is also a need for a commonly supported, multiple-display sign holder to be able to have one or more of its displays changed easily. Those multiple signs by that site holder ought also to be changeable independently from one another.

One such unique sign holder assembly is shown in U.S. Pat. No. 6,546,658, to Pitcher et al. However, this sign holder does not support more than one sign at a time.

It is thus an object of the present invention to improve the upon the prior art.

It is a further object of the present invention to provide a sign support arrangement which is readily changed by store personnel with minimum complexity.

It is yet a further object of the present invention to provide a signed support arrangement which permits multiple signs to be supported from a common member.

Is yet still a further object of the present invention, to permit a multiple signs support for commercial establishments, wherein anyone of those supported signs may be changed without affecting any of the other signs supported therefrom.

### BRIEF SUMMARY OF THE INVENTION

The present invention comprises an elongated sign receiving and supporting arrangement for supporting a plurality of signs independently of one another. The elongated sign receiving and support arrangement in a first embodiment thereof, comprises an elongated extrusion having an elongated, upper support-receiving channel arranged on an elongated upper edge of a elongated spine. The upper support receiving channel has a pair of parallel sides having an inwardly directed flange along each upper edge thereof, spaced apart yet facing one another, and an outwardly directed, inverted “J” shaped flange on each of the parallel side walls as well.

The elongated spine has a lower edge with an inverted “U”-shaped gripper-receiving channel arranged thereon. The elongated griper-receiving channel has a pair of parallel spaced apart lower edges of outwardly directed, upwardly facing “J” shaped configuration arranged thereon. The inverted (downwardly facing) “J” shaped flanges adjacent elongated upper support receiving channel and the upwardly directed “J” shaped channels on the lower edges of the gripper-receiving channel define slots for receipt of the edges of an elongated side display panel further described hereinbelow. The gripper receiving channel has a pair of inwardly directed flanges, spaced apart from one another at an upper end thereof, to define an elongated pinch-gripper support channel therebetween.

A pair of generally “T”-shaped backer-flanges extend along each side of the elongated spine along a longitudinal midline thereof, to provide a backing support to any side display panel supported within the upper and lower “J”-shaped flange arrangements thereon.

An elongated pinch gripper member may be inserted within the gripper receiving channel, which pinch gripper member may be seen in U.S. Pat. No. 6,546,658, incorporated herein by reference, in its entirety. The elongated pinch gripper member has an upper edge of “T”-shape in cross-section. The “T”-shaped portion of the elongated gripper member is slidably received in the elongated gripper-support channel along the upper edge of the gripper receiving channel. The elongated pinch gripper member is arranged to biasedly receive a display panel therein. When the elongated pinch gripper member is slid into the elongated gripper support channel, the lower display may thus be supported therein, the further display sign being suspended beneath the elongated sign receiving arrangement.

A further embodiment of the elongated sign receiving arrangement, in a height-wise lower version thereof, comprises a pair of extruded, elongated sidewalls defining an upper support receiving channel therebetween. The sidewalls each have an upper edge having an inverted upper “J”-shaped flange extending outwardly therealong, the upper edge of the elongated sidewalls also having a pair of spaced apart flanges extending inwardly towards one another along the length of that channel. A bridging member extends between the upper side portions of the two elongated sidewalls to further define therewith, that upper support receiving channel thereby.

A flange extends along each sidewall, adjacent to the bridge member, to define a gripper support channel therebetween. An elongated pinch gripper member similar to the aforementioned embodiment, having an upper elongated “T”-shape edge thereon, may be slidingly received within that elongated gripper support channel. The elongated pinch gripper member is arranged to support a lower display panel received between the biased portions thereof.

A side display panel may be slidingly received between the upwardly directed lower “J”-shaped flanges and the downwardly directed upper “J” shaped flanges.

The invention thus comprises An elongated, extruded, sign holder for holding a plurality of readily changeable independently supported elongated signs comprising, an elongated extrusion having an upper channel arranged on an upper edge of the extrusion; an elongated lower channel arranged on a lower edge of the extrusion; an elongated independent sign receiving arrangement arranged on a first side of the sign holder; an elongated independent sign receiving arrangement arranged on a second side of the sign holder; and an elongated independent sign receiving arrangement arranged on a lower edge of the sign holder. The upper channel comprises an overhead support receiving channel. The independent sign receiving arrangement on the lower edge of the sign holder comprises a gripper support channel. The elongated independent sign receiving arrangement on the first side of the sign holder comprises a pair of “J”-shaped channels openly facing one another. The elongated independent sign receiving arrangement on the second side of the sign holder comprises a pair of “J”-shaped channels openly facing one another. The independent sign receiving arrangement on the lower edge of the sign holder comprises a gripper receiving channel. The gripper support channel is defined by a pair of spaced apart flanges and a bridging member. The gripper receiving channel receives an elongated gripping receiving member.

The invention also comprises an elongated system for independently supporting a plurality of elongated signs from a plurality of sides and edges thereof from a common extrusion, comprising: a slidable first side sign holder; a slidable second side sign holder; a slidable lower edge third sign holder; and an end cap arranged at each end of the system for securing the plurality of signs within the system. The end caps each have a finger pivotably disposed in an upper support receiving channel. The end caps are pivotable with respect to the support channel. The system includes a sign backer member to keep any sign supported thereagainst from bowing inwardly. The sign backer member comprises a pair of “T”-shaped flanges extending off of the common extrusion. The slidable first sign holder comprises a pair of parallel, spaced apart “J” shaped flanges facing one another on a first side of the common extrusion. The slidable second sign holder comprises a pair of parallel, spaced apart “J” shaped flanges facing one another on a second side of the common extrusion. The slidable lower edge third sign holder comprises a pair of parallel, spaced apart inwardly directed flanges facing one another of the common extrusion for engaging and supporting an elongated gripper member.

### BRIEF DESCRIPTION OF THE DRAWINGS

The objects and advantages of the present invention will become more apparent, and viewed in conjunction with following drawings in which:

FIG. 1 is a perspective view of a first embodiment of the elongated sign receiving arrangement constructed according to the principles of the present invention;

FIG. 2 is a view similar to FIG. 1 showing how an elongated sign is received in a side portion thereof;

FIG. 3 is an end view of the elongated side receiving arrangement;

FIG. 4 is an end to view similar to that shown in FIG. 3 with a side display panel shown within the side portions thereof and an elongated pinch group or in a lower portion of the sign receiving arrangement, with a lower display suspended therefrom;

FIG. 5 is a perspective view of a second embodiment of the elongated side receiving arrangement constructed according to the principles of the present invention;

FIG. 6 is a view similar to FIG. 1 show and how would elongated sign is received in a side portion thereof; and

FIG. 7 is an end view of the second embodiment of the elongated sign receiving arrangement shown with a elongated gripper member inserted therewithin.

### DETAILED DESCRIPTION OF THE PREFERRED EMBODIMENTS

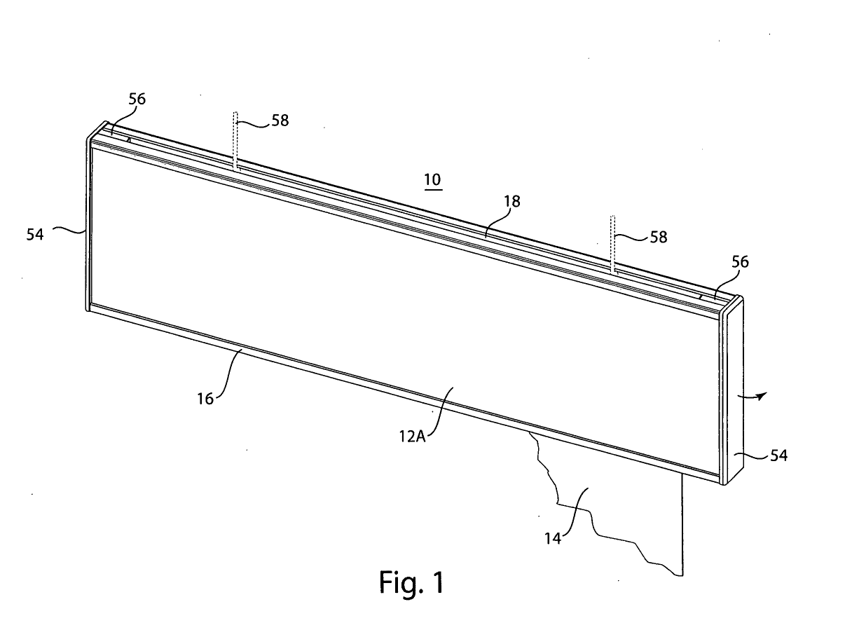

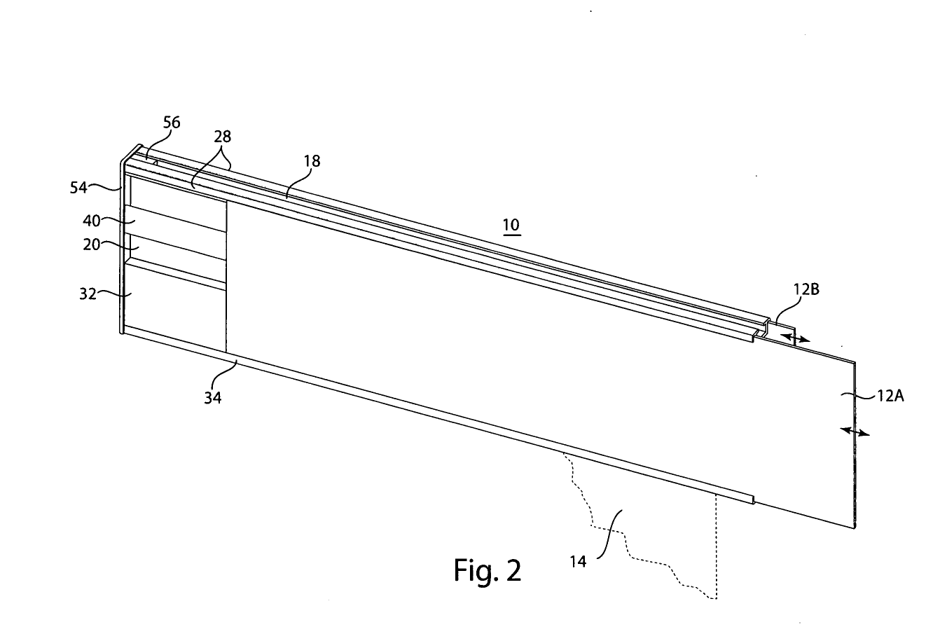

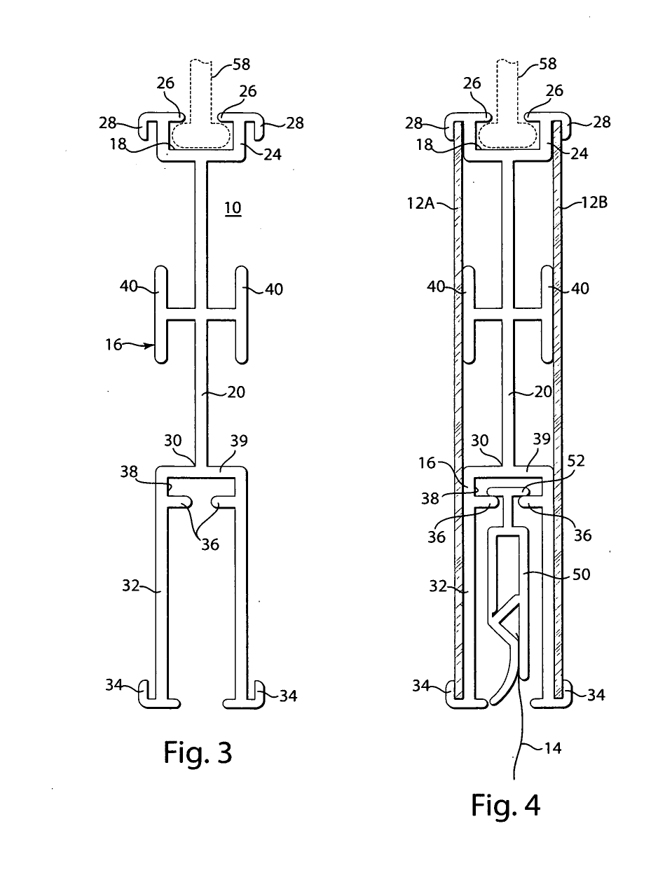

Referring now to the drawings in detail and particularly to FIGS. 1 and 2, there is shown an elongated multi-sign receiving and supporting arrangement 10 for supporting a plurality of changeable signs 12A, 12B and 14, independently of one another. The elongated sign receiving and support arrangement 10, in a first embodiment thereof, as represented in FIGS. 1, 2, 3 and 4 comprises an elongated extrusion 16 having an elongated, upper support-receiving channel 18, arranged on an elongated upper edge of a elongated spine 20, is best seen in FIGS. 3 and 4. The upper support receiving channel 18 has a pair of parallel sides 22 and 24 having an inwardly directed flange 26 along each upper edge thereof, spaced apart, yet facing one another, and an outwardly directed, inverted “J” shaped flange 28, on each of the parallel side walls 22 and 24 as well, as shown in FIGS. 3 and 4.

The elongated spine 20 has a lower edge 30 with an inverted “U”-shaped gripper-receiving channel 32 arranged thereon, having a connecting bridge member 39 thereon, as shown in FIGS. 3 and 4. The elongated griper-receiving channel 32 has a pair of parallel spaced apart lower edges 34 of outwardly directed, upwardly facing “J” shaped configuration arranged thereon. The inverted (downwardly facing) “J” shaped flanges 28 adjacent elongated upper support receiving channel 18 and the upwardly directed “J” shaped channels 34 on the lower edges of the gripper-receiving channel 32 define slots for receipt of the edges of the elongated side display panels 12A and 12B further described hereinbelow. The gripper receiving channel 32 has a pair of inwardly directed flanges 36, spaced apart from one another at an upper end thereof, to define an elongated pinch-gripper support channel 38 therebetween.

A pair of generally “T”-shaped backer-flanges 40 extend along each side of the elongated spine 20, along a longitudinal midline thereof, as shown in FIGS. 3 and 4, to provide a backing support to any side display panel 12A and 12B slidably supported within the upper and lower “J”-shaped flange arrangements 28 and 34, thereon, as shown in FIG. 4.

An elongated pinch gripper member 50 may be inserted within the gripper receiving channel, as shown in FIG. 4. The pinch gripper member 50 may be seen more specifically in U.S. Pat. No. 6,546,658, incorporated herein by reference, in its entirety. The elongated pinch gripper member 50 has an upper edge 52 of “T”-shape in cross-section. The “T”-shaped upper edge 52 of the elongated gripper member 50 is slidably received in the elongated gripper-support channel 38 along the upper edge of the gripper receiving channel 32, as shown in FIG. 4. The elongated pinch gripper member 50 is arranged to biasedly receive the lower display panel or sign 14 therein. When the elongated pinch gripper member 50 is slid into the elongated gripper support channel 38, the lower display sign 14 may thus be supported therein, as shown in FIGS. 1, 2 and 4, the further display sign being suspended beneath the elongated sign receiving arrangement 10.

A pivotable end cap 54 is shown in FIGS. 1 and 2 for covering the ends of the channels 18 and 38, to keep any display signs 12A, 12B and 14 maintained therein. Each end cap 54 has a pivot finger 56 insertable into the upper channel 18 to keep the end caps 54 (and any signs) in place. An overhead support 58 is shown in phantom in FIGS. 1 2, 3 and 4, which support 58 is attachable at an upper end thereof, to a ceiling or overhead support, not shown for clarity of the drawings.

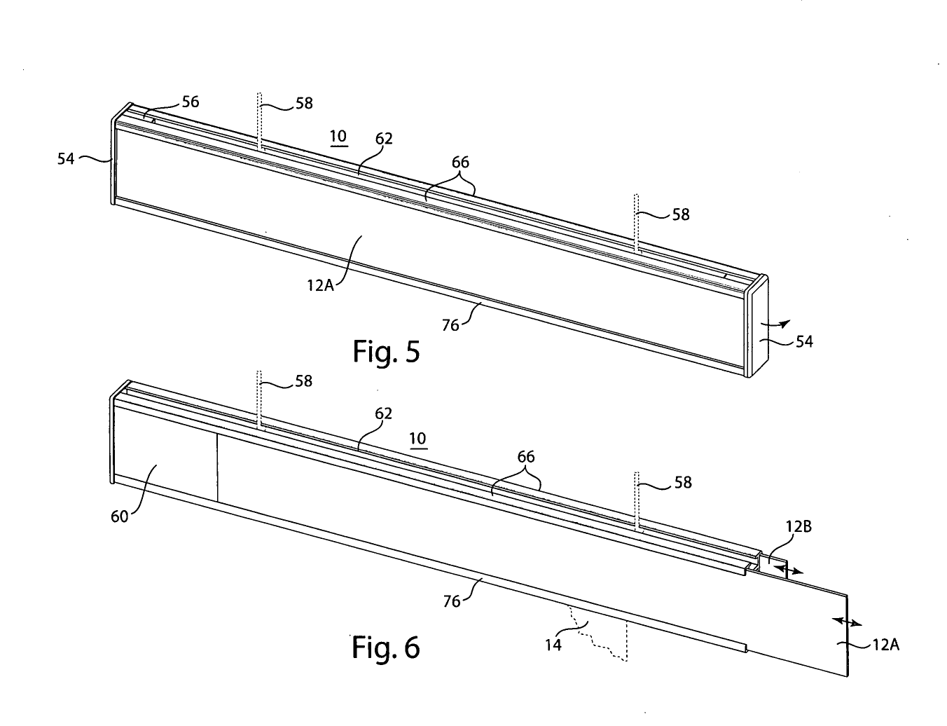

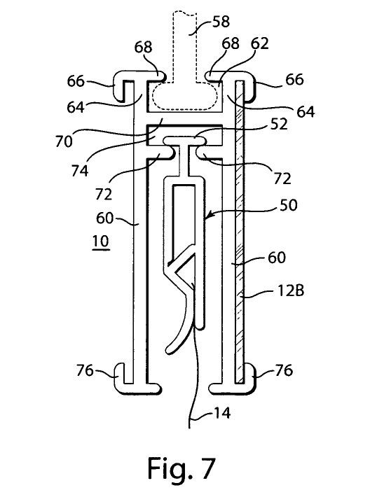

A further embodiment of the elongated sign receiving arrangement 10, in FIGS. 5, 6 and 7, in a height-wise “lower” version thereof. The elongated multi-sign receiving arrangement 10 comprises a pair of extruded, elongated sidewalls 60 defining an upper support receiving channel 62 therebetween, as shown in FIG. 7. The sidewalls 60 each have an upper edge 64 having an inverted upper “J”-shaped flange 66 extending outwardly therealong, the upper edge 64 of the elongated sidewalls 60 also having a pair of spaced apart flanges 68 extending inwardly towards one another along the length of that channel 62, as shown best in FIG. 7. A bridging member 70 extends between the upper side portions of the two elongated sidewalls 60 to further define therewith, that upper support receiving channel 62 thereby.

A flange 72 extends inwardly, along each sidewall 60, adjacent to the bridge member 70, to define a gripper support channel 74 therebetween. An elongated pinch gripper member 50 similar to the aforementioned embodiment, having an upper elongated edge 52 thereon, of “T”-shape in cross-section, may be slidingly received within that elongated gripper support channel 74. The elongated pinch gripper member 50 is arranged to support a lower display panel 14 received between the biased portions thereof.

A pair of side display panels 12A and 12B may be slidingly received between the upwardly directed lower “J”-shaped flanges 76 and the downwardly directed upper “J” shaped flanges 66, at the lower edge of the side walls 60, as shown in FIGS. 5, 6 and 7. An overhead support 58 having an enlarged lower end received in the upper channel 70, is shown in FIGS. 5, 6 and 7, in phantom, in a manner similar to the earlier embodiment. Similarly, end caps 54 may be pivotably secured by end cap fingers 56 to the ends of the upper channel 62 and elongated sign receiving arrangement 10, as was recited in the aforementioned embodiment.

We claim:

1. An elongated, extruded, sign holder for holding a plurality of readily changeable independently supported elongated signs comprising:
an elongated extrusion having an upper channel arranged on an upper edge of the extrusion;
an elongated lower channel arranged on a lower edge of the extrusion;
an elongated independent sign receiving arrangement arranged on at least a first side of the sign holder; and
an elongated independent sign receiving arrangement arranged on a second side of the sign holder.

2. The elongated sign holder as recited in claim 1, wherein the upper channel comprises an overhead support-member receiving channel for receiving an overhead support member.

3. The elongated sign holder as recited in claim 1, wherein the lower channel comprises a lower slidable sign holding arrangement.

4. The elongated sign holder as recited in claim 3, wherein the independent sign receiving arrangement on the lower edge of the sign holder comprises a gripper-support channel.

5. The elongated sign holder as recited in claim 1, wherein the elongated independent sign receiving arrangement on the first side of the sign holder comprises a pair of “J”-shaped channels openly facing one another.

6. The elongated sign holder as recited in claim 1, wherein the elongated independent sign receiving arrangement on the second side of the sign holder comprises a pair of “J”-shaped channels openly facing one another.

7. The elongated sign holder as recited in claim 1, wherein the independent sign receiving arrangement on the lower edge of the sign holder comprises a gripper receiving channel.

8. The elongated sign holder as recited in claim 4, wherein the gripper support channel is defined by a pair of spaced apart flanges and a bridging member.

9. The elongated sign holder as recited in claim 4, wherein the gripper receiving channel receives an elongated gripping receiving member.

10. An elongated system for independently supporting a plurality of elongated signs from a plurality of sides and edges thereof from a common extrusion, comprising:
a first slidable side sign holder;
a second slidable side sign holder; and
a lower edge third slidable sign holder, wherein each of the slidable sign holders are arranged to hold signs independently of one another.

11. The elongated system for supporting signs as recited in claim 10, including:
an end cap arranged at each end of the system for securing the plurality of signs within the system.

12. The elongated system as recited in claim 11, wherein the end caps each have a finger pivotably disposed in an upper support receiving channel.

13. The elongated system as recited in claim 12, wherein the end caps are pivotable with respect to the support channel.

14. The system as recited in claim 10, including a sign backer member to keep any sign supported thereagainst from bowing inwardly.

15. The system as recited in claim 14, wherein the sign backer member comprises a pair of “T”-shaped flanges extending off of the common extrusion.

16. The system as recited in claim 10, wherein the first slidable sign holder comprises a pair of parallel, spaced apart “J” shaped flanges facing one another on a first side of the common extrusion.

17. The system as recited in claim 10, wherein the second slidable sign holder comprises a pair of parallel, spaced apart “J” shaped flanges facing one another on a second side of the common extrusion.

18. The system as recited in claim 10, wherein the lower edge third slidable sign holder comprises a pair of parallel, spaced apart inwardly directed flanges facing one another of the common extrusion for engaging and supporting an elongated gripper member.

19. An elongated, extruded, sign holder for holding a plurality of readily changeable independently supported elongated signs comprising:
an elongated extrusion having an upper channel arranged on an upper edge of the extrusion;
an elongated independent sign receiving arrangement arranged on a first side of the sign holder;
an elongated independent sign receiving arrangement arranged on a second side of the sign holder; and
an elongated lower sign receiving channel arranged on a lower edge of the extrusion for independently holding a sign thereby.

20. The elongated, extruded, sign holder as recited in claim 19, wherein each of the sign receiving arrangements are arranged to slidably receive and slidably have signs removed therefrom.
